(19) United States
(12) Patent Application Publication
(10) Pub. No.: US 2009/0055881 A1
(43) Pub. Date: Feb. 26, 2009

(54) DIGITAL BROADCAST RECEIVER

(76) Inventors: Hiroshi AOKI, Hiroshima (JP); Tsuneki Yasuho, Osaka (JP); Yasunobu Kanzaki, Hyogo (JP); Keisuke Iwata, Osaka (JP); Tsuyoshi Ide, Osaka (JP); Tatsuto Horibe, Hyogo (JP)

Correspondence Address: WENDEROTH, LIND & PONACK L.L.P., 2033 K. STREET, NW, SUITE 800, WASHINGTON, DC, 20006, US

(21) Appl. No.: 12/194,953

(22) Filed: Aug. 20, 2008

(30) Foreign Application Priority Data
Aug. 22, 2007 (JP) 2007-215520

(51) Int. Cl. H04N 7/173

(52) U.S. Cl. 725/100

(57) ABSTRACT

There is provided a cable broadcast receiver for solving problems arising in the switching between execution of a download application and reproduction of video audio information from an external device. The receiver has operating modes including a first mode and a second mode. Under the first mode, the receiver is operated based on a download application acquired through a network. Under the second mode, the receiver is operated based on a receiver application. The receiver is operated under the second mode when information inputted from an external device is to be displayed. A key delivery unit delivers, upon receiving a key code instructing a channel change during the operation under the second mode, the key code indicating the channel change to a download application management unit which controls the key delivery to the download application, and a receiver application management unit which controls the key delivery to the receiver application.

### BACKGROUND OF THE INVENTION

1. Field of the Invention

The present invention relates to a receiver of a digital broadcast such as a cable broadcast.

2. Related Art

A conventional receiver (referred to as “IDTV”) retains an originally installed application (referred to as “receiver application”). The IDTV is connected to an external device and can reproduce video audio information inputted from the external device (referred to as “external input mode”). According to the IDTV, its channel selection and switching to the external input mode are executed by the receiver application.

Recently, the cable broadcast is increasingly digitalized and various kinds of services are provided. The various kinds of techniques for the receiver of the cable broadcast have been developed (refer to JP 2006-511106 A). The OCAP (Open Cable Application Platform) has been proposed as standards of next-generation cable broadcast for North America.

According to the OCAP, a receiver such as a STB (Set Top Box) can download, from a broadcasting station, various kinds of applications (Java (registered trademark) application)) such as an application for watching an electronic program guide (EPG) and a VOD (Video on Demand). When the downloaded application is executed based on an API (Application Program Interface) defined by the OCAP standards, a certain function can be implemented. This kind of receiver (referred to as “OCAPTV”) checks whether a download application or the like to be transmitted from the station periodically is delivered or not and executes the download application when it is delivered.

The OCAPTV also incorporates a receiver application. The OCAPTV has an operation mode in which the download application is executed (referred to as “OCAP mode” hereinafter), and an operation mode in which the receiver application is executed (referred to as “IDTV mode (or non-OCAP mode)” hereinafter). Channel selection of the OCAP mode is performed by the download application. The external input mode is contained in the non-OCAP mode and controlled by the receiver application.

The OCAPTV only operates the download application based on the determined API, and the receiver application of the OCAPTV does not recognize a specific function implemented by the download application. Therefore, the OCAPTV has various kinds of problems in the switching between the OCAP mode and the external input mode. For example, a description will be made of the case where a user presses a channel UP/DOWN key under the external input mode.

When the user presses the channel UP/DOWN key under the external input mode, the key is delivered to the receiver application. In the case of the IDTV, since the channel selection is controlled by the receiver application, the receiver application that received the channel UP/DOWN key can switch the external input mode to the display of the channel designated by the channel UP/DOWN key. Meanwhile, when the OCAPTV is operated under the OCAP mode, the channel selection is controlled by the download application. Even when the receiver application of the OCAPTV receives the channel UP/DOWN key, it cannot select the channel of the download application. Therefore, when the user presses the channel UP/DOWN key under the external input mode, the external input mode cannot be switched to the display of the channel of the download application designated by the channel UP/DOWN key. Thus, the OCAPTV has various kinds of problems in the switching between the OCAP mode and the external input mode.

### SUMMARY OF THE INVENTION

The present invention was made to solve the above problems, and it is an object of the present invention to provide a cable broadcast receiver that can solve the problems arising according to the switching between the OCAP mode and the external input mode.

According to a first aspect of the present invention, a digital broadcast receiver has operating modes including a first mode and a second mode. Under the first mode, the receiver is operated based on a download application acquired through a network. Under the second mode, the receiver is operated based on an incorporated receiver application. The receiver is operated under the second mode when information inputted from an external device is to be displayed. The receiver include: a download application management unit that controls whether or not to deliver a key code to the download application; a receiver application management unit that controls whether or not to deliver a key code to the receiver application; and a key delivery unit that delivers a key code outputted from a remote controller to the download application and/or the receiver application. The key delivery unit delivers, upon receiving a key code instructing a channel change during the operation under the second mode, the key code instructing the channel change to both of the download application management unit and the receiver application management unit.

When the key delivery unit receives the key code instructing the channel change while the receiver application is displaying an emergency alert broadcast, the key delivery unit may deliver the key code to both of the download application management unit and the receiver application management unit.

According to a second aspect of the present invention, a digital broadcast receiver has operating modes including a first mode and a second mode. Under the first mode, the receiver is operated based on a download application acquired through a network. Under the second mode, the receiver is operated based on an incorporated receiver application. The receiver is operated under the second mode when information inputted from an external device is to be displayed. The receiver includes: a decoder that decodes digital data from the download application and the external device; and a resource management unit that manages a resource of the decoder used by the download application or the receiver application. The download application has a first condition in which the resource is acquired to display a screen, and a second condition in which the condition of the resource is retained. When an operating mode is switched from the first mode to the second mode, the download application changes from the first condition to the second condition, and when an operating mode is switched from the second mode to the first mode, the download application changes from the second condition to the first condition, to reset the resource managed by the resource management unit, based on the retained resource condition.

According to a third aspect of the present invention, a digital broadcast receiver has operating modes including a first mode and a second mode. Under the first mode, the receiver is operated based on a download application acquired through a network. Under the second mode, the receiver is operated based on an incorporated receiver application. The receiver is operated under the second mode when information inputted from an external device is to be displayed. The receiver includes: a download application management unit that controls whether or not to deliver a key code to the download application; a receiver application management unit that controls whether or not to deliver a key code to the receiver application; and a key delivery unit that delivers a key code outputted from a remote controller to the download application management unit and/or the receiver application management unit. The key delivery unit delivers a key code to the download application through the download application management unit when the key code indicates the switching from the first mode to the second mode, the download application determines whether or not the switching from the first mode to the second mode can be performed, and when the switching can be performed, the download application returns the key code to the receiver application management unit through the download application management unit, but when the switching cannot be performed, the download application does not return the key code to the receiver application management unit or the download application returns the key code to the receiver application management unit with information for prohibiting the switching, and the receiver application management unit delivers the key code to the receiver application when the key code is returned and the information for prohibiting the switching is not added.

According to a fourth aspect of the present invention, a digital broadcast receiver has operating modes including a first mode and a second mode. Under the first mode, the receiver is operated based on a download application acquired through a network. Under the second mode, the receiver is operated based on an incorporated receiver application. The receiver is operated under the second mode when information inputted from an external device is to be displayed. The receiver includes: a download application management unit that controls whether or not to deliver a key code to the download application; a receiver application management unit that controls whether or not to deliver a key code to the receiver application; a key delivery unit that delivers a key code outputted from a remote controller to the download application management unit and/or the receiver application management unit, and a download application condition management unit that manages a condition of the download application. When the key delivery unit receives, under the second mode, a key code of a key for performing a toggle operation for the first mode, the key delivery unit delivers the key code to the receiver application management unit and the download application management unit, and when the download application management unit receives the key code, the download application management unit inquires of the download application condition management unit about a condition of the download application, and when the download application management unit determines that inversion of the toggle operation is necessary based on the result of the inquiry, the key code is delivered to the download application.

According to the present invention, the above problems arising in the switching between the OCAP mode and the external input mode can be solved. For example, even in the case where a user presses a channel UP/DOWN key under the external input mode, the channel of the download application designated by the channel UP/DOWN key can be displayed.

### BRIEF DESCRIPTION OF THE DRAWINGS

FIG. 1 is a view showing the hardware configuration of a receiver for receiving a cable broadcast according to an embodiment of the present invention;

FIG. 2 is a view showing the functional configuration of the receiver according to the embodiment;

FIG. 3A is a view showing the transition of screens when a channel UP/DOWN key is pressed during an external input mode, and FIG. 3B is a view showing the transition of screens when the channel UP/DOWN key is pressed during an EAS forced channel selection;

FIG. 4 is a flowchart corresponding to FIG. 3A;

FIG. 5 is a view showing a path of key delivery corresponding to FIG. 4;

FIG. 6 is a flowchart corresponding to FIG. 3B;

FIG. 7A is a view showing the condition in which a resource is managed under an OCAP mode, and FIG. 7B is a view showing the condition in which the resource is managed under the external input mode;

FIG. 8 is a view showing the condition transition of the OCAP mode;

FIG. 9 is a flowchart showing the control of the condition transition of an OCAP application by a receiver application management unit, a receiver application, and an OCAP application management unit when the OCAP mode and the external input mode are switched;

FIG. 10 is a flowchart showing the control of the condition transition of the OCAP application itself when the OCAP mode and the external input mode are switched;

FIG. 11A is a view showing a path when a key is delivered only to the OCAP application, FIG. 11B is a view showing a path when a key is delivered only to the receiver application, FIG. 11C is a view showing a path when a key is delivered to the OCAP application and the receiver application;

FIG. 12 is a view showing a path when an input switch key is delivered according to the embodiment;

FIG. 13A, FIG. 13B, and FIG. 13C are views when an operation mode is switched from the OCAP mode to the external input mode, and an EPG key is pressed under the external input mode, in which FIG. 13A is a transition view in the case where the EPG is not displayed under the first OCAP mode, FIG. 13B is a conventional transition view in the case where the EPG is already displayed under the first OCAP mode, and FIG. 13C is a transition view in the case where the EPG is already displayed under the first OCAP mode according to the embodiment;

FIG. 14 is a flowchart showing the activation control of the EPG key based on the press of the EPG key; and

FIG. 15 is a view showing a path of the delivery of the EPG key.

### DETAILED DESCRIPTION OF THE PREFERRED EMBODIMENTS

Preferred embodiments of the present invention are described below with reference to the accompanying figures.

### Embodiment

### 1. Hardware Configuration of Receiver

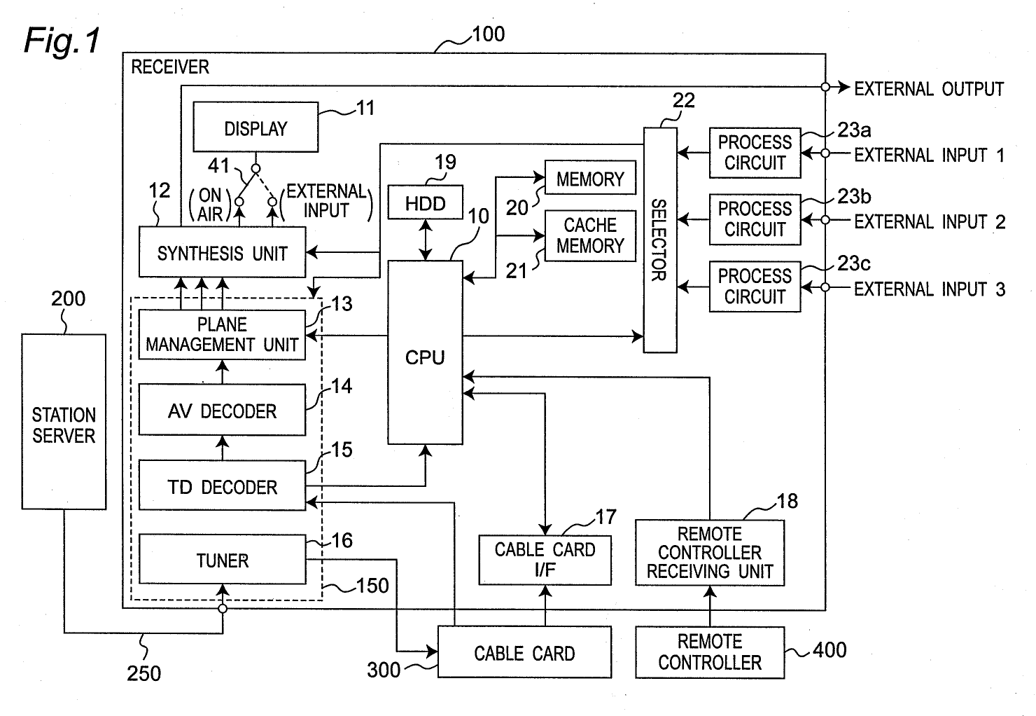

FIG. 1 is a view showing the hardware configuration of a receiver for receiving a cable broadcast according to one embodiment of the present invention. A receiver 100 according to this embodiment can receive the cable broadcast in conformity with OCAP (Open Cable Application Platform) standards. (Refer to “OpenCable™ Application Platform Specifications, OCAP1.0 Profile, OC-SP-OCAP1.0.1-070824”.) The configuration for processing an audio signal is omitted to simplify the description in FIG. 1.

A cable card 300 for receiving the cable broadcast is inserted into the receiver 100. The cable card 300 is a card for receiving the broadcast from a specific cable broadcast station. The receiver 100 includes a cable card interface 17 for exchanging data with the cable card 300.

The receiver 100 includes a remote controller receiving unit 18 for receiving a signal from a remote controller 400. The receiver 100 receives user operation information (key code) through the remote controller 400 and performs a process corresponding to the operation.

The receiver 100 is connected to a server 200 through a cable 250. The server 200 is set in the cable broadcast station and provides the cable broadcast.

The receiver 100 has a tuner 16, a TD decoder 15, and an AV decoder 14 to reproduce the cable broadcast. The tuner 16 receives a signal delivered from the cable broadcast station through the cable 250. The TD decoder 15 demultiplexs a transport stream containing audio, video, and data which are multiplexed. The AV decoder 14 decodes audio and video data in an MPEG format delivered from the cable station. Referring to FIG. 1, the tuner 16, the TD decoder 15, the AV decoder 14, and a plane management unit 13 are collectively referred to as a decoder 150.

The receiver 100 has an input system (external input 1, external input 2 and external input 3) for inputting video audio information from a plurality of external devices other than the information from the cable broadcast. The external inputs are connected to process circuits 23a to 23c for processing a video audio signal, respectively and a selector 22 selects one of the outputs of the process circuits 23a to 23c.

A CPU 10 is a controller to control the operation of the receiver 100. The CPU 10 is connected to a hard disk drive (HDD) 19 as data storing means, a volatile memory 20, and a cache memory 21 as nonvolatile storing means.

The plane management unit 13 holds a plane displayed on a display 11. The plane includes a receiver application plane, an OCAP application plane, and an external input plane. A synthesis unit 12 synthesizes these planes. The synthesized plane is displayed on the display 11, or outputted from an external output to the external device such as a recording device.

The display 11 processes the video outputted from the synthesis unit 12 and displays it. More specifically, the display 11 inputs, through a switch 41, the video reproduced by a factory-installed application (referred to as “receiver application” hereinafter) or an application obtained from the server 200 of the cable broadcast station by downloading (referred to as “OCAP application” hereinafter), or the video of the external input selected by the selector 22 and displays it. In addition, according to the receiver 100 in this embodiment, any one of the cable broadcast and the external inputs 1 to 3 is selected by the CPU 10 based on the user operation and outputted to the display 11.

### 2. Functional Configuration of Receiver

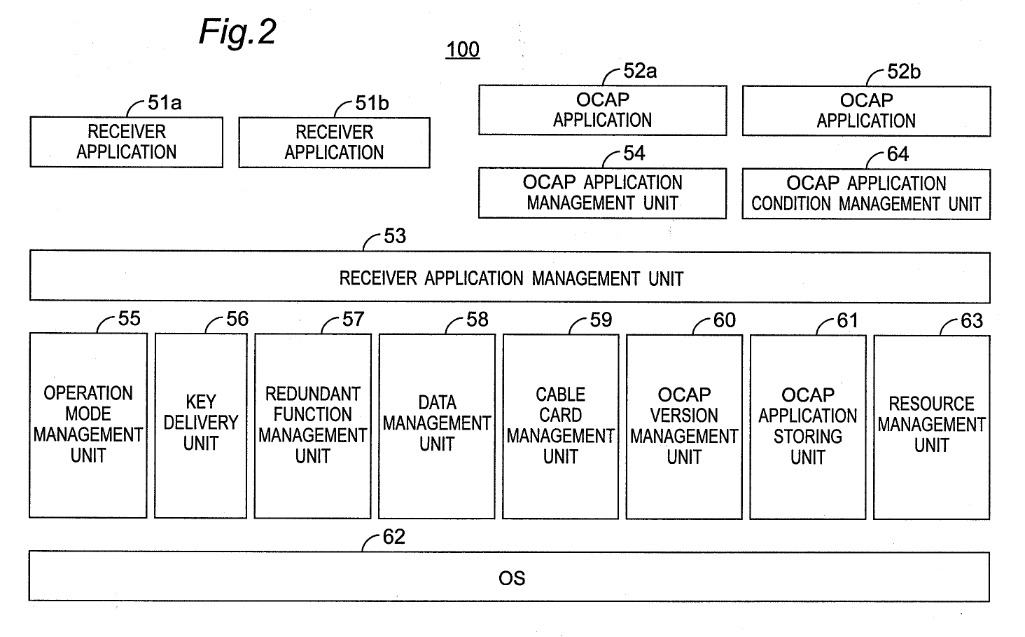

FIG. 2 shows the functional configuration of the receiver 100. The functional configuration shown in FIG. 2 is implemented by executing a certain program by the CPU 10. Only the main functions are shown in FIG. 2 in view of simplicity of the description. Thus, it is needless to say that the functions of the receiver 100 that will be described below can be implemented by executing a certain program by the CPU 10 although the functions are not shown in FIG. 2.

As shown in FIG. 2, the receiver 100 includes receiver applications 51a and 51b, and OCAP applications 52a and 52b. The receiver applications 51a and 51b, and the OCAP applications 52a and 52b include a channel select application, an EAS (Emergency Alert System) display application, a banner display application, a parental control display application, a setting application and the like. In addition, the receiver applications 51a and 51b include an input control application for controlling the switching to an external input mode in which the video audio information from the external device is reproduced and displayed.

An OCAP application management unit 54 is a middleware for executing the OCAP applications 52a and 52b, and controls the activation of the OCAP applications 52a and 52b and key delivery. A receiver application management unit 53 controls the activation of the receiver applications 51a and 51b and key delivery, and controls the activation of the OCAP application management unit 54.

An OCAP application condition management unit 64 manages the conditions of the OCAP applications 52a and 52b. More specifically, it manages whether an EPG (Electronic Program Guide), a VOD and a menu is being displayed or not.

An operation mode management unit 55 is a module for managing the operation mode of the receiver 100. The operation mode includes an operation mode to execute the OCAP application (referred to as “OCAP mode” hereinafter), and an operation mode to execute the receiver application (referred to as “IDTV mode (or non-OCAP mode)” hereinafter) The operation mode management unit 55 manages the conditions of the receiver applications 51a and 51b and the conditions of the OCAP applications 52a and 52b obtained from the OCAP application management unit 54, and informs a redundant function management unit 57 of each condition when these conditions are changed.

A key delivery unit 56 delivers, based on a content of a key code (for example, “VK_GUIDE”, “VK_ON_DEMAND”, and “VK_MENU”) from the remote controller 400, the key code to the receiver application management unit 53 and/or the OCAP application management unit 54. For example, when the key code is only for the receiver applications 51a and 51b, the key delivery unit 56 delivers the key code only to the receiver application management unit 54, and when the key code is only for the OCAP applications 52a and 52b, the key delivery unit 56 delivers the key code only to the OCAP application management unit 54. In addition, when the key code is common to the receiver applications 51a and 51b and the OCAP applications 52a and 52b, the key delivery unit 56 transmits the key code to both of the receiver application management unit 53 and the OCAP application management unit 54, or only to the receiver application management unit 53 or only to the OCAP application management unit 54. For example, the key code of a channel UP/DOWN key during the execution of the OCAP application is transmitted only to the OCAP application management unit 54 and it is not transmitted to the receiver application management unit 53. When the channel UP/DOWN key is pressed under the condition that the menu of the receiver 100 is displayed, the key code is transmitted only to the receiver application management unit 53.

The redundant function management unit 57 determines exclusion/share of the receiver applications 51a and 51b and the OCAP applications 52a and 52b. Furthermore, the redundant function management unit 57 retains the information of the exclusion/share.

A data management unit 58 manages initial data and manages data updated in the receiver applications 51a and 51b or the OCAP applications 52a and 52b. For example, the data management unit 58 manages PIN (Personal Identification Number) information and parental information or the like.

A cable card management unit 59 is a module that receives, manages and executes the request from the cable card 300.

An OCAP version management unit 60 manages the version of the OCAP applications 52a and 52b retained in an OCAP application storing unit 61, and performs a version-up process of the OCAP applications 52a and 52b based on a received XAIT (Extended Application Information Table). The XAIT is the management information of the download application transmitted from the cable broadcast station, and it contains the information of the storage location of the application (for example, the information of URL of the server 200) and the information of the application to be activated. The OCAP application storing unit 61 retains the downloaded OCAP applications 52a and 52b.

A resource management unit 63 manages a resource of the decoder 150 used by the OCAP application and the receiver application. An OS (Operation System) 62 is a software for controlling the whole receiver 100.

### 3. Control for Switching Between OCAP Mode and External Input Mode

The various functions of the receiver 100 having the above configuration in this embodiment will be described hereinafter. Although the two receiver applications 51a and 51b and the two OCAP applications 52a and 52b are shown in FIG. 2, the description will be made with the receiver application 51a and the OCAP application 52a hereinafter.

3.1 Control when Channel UP/DOWN Key is Pressed

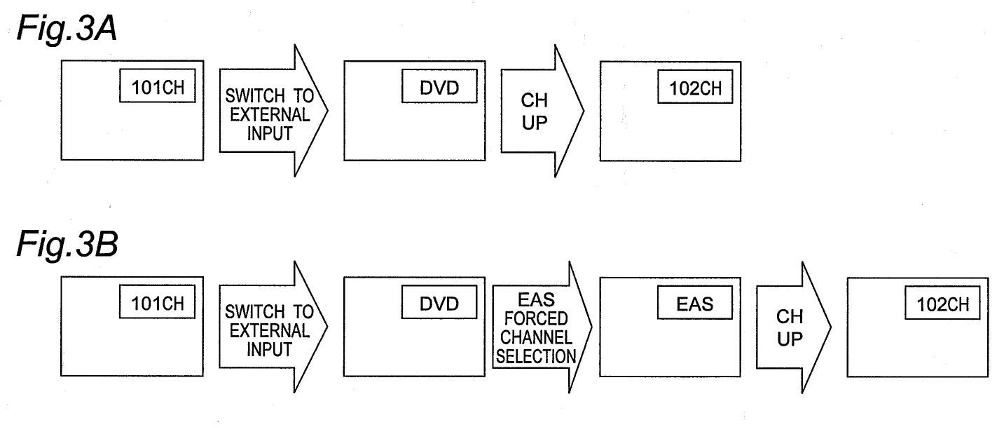

FIG. 3A shows the transition of the screen of the display 11 displayed when the channel UP/DOWN key of the remote controller 400 is pressed by the user while the video information inputted from the external device is being displayed on the display 11 after the OCAP mode is switched to the external input mode. For example, while a “101ch” is selected under the OCAP mode, when the mode is switched to the external input mode and then the channel UP/DOWN key is pressed, a “102ch” cannot be displayed back under the OCAP mode in the conventional case. Meanwhile, according to the present invention, the “102ch” can be displayed back under the OCAP mode.

FIG. 3B shows the transition of the screen of the display 11 displayed when the channel UP/DOWN key of the remote controller 400 is pressed by the user while the emergency alert broadcast is being displayed. An EAS (Emergency Alert System), in which character information of the emergency alert broadcast is displayed on a part of the display and a program for the emergency alert broadcast is forcedly selected when a disaster strikes, has been employed in America (Refer to SCTE18 standard). The receiver application 51a has a function to display the emergency alert broadcast, that is, an EAS function. When the emergency alert is generated under the external input mode, the receiver application 51a displays the forcedly selected emergency alert broadcast on the display 11 for a certain period (10 seconds, for example). When the forced channel selection is executed by the receiver application 51a, even when the channel UP/DOWN key is pressed during the forced channel selection, the “102ch” cannot be displayed back in the OCAP in the conventional case. Meanwhile, according to the present invention, the “102ch” can be displayed back under the OCAP mode.

3.1.1 Control when Channel UP/DOWN Key is Pressed Under External Input Mode

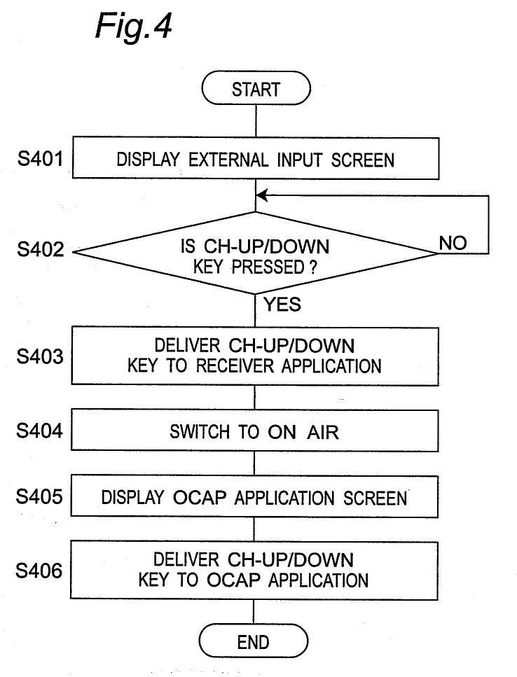

FIG. 4 shows a flowchart corresponding to FIG. 3A. Under the external input mode, the switch 41 shown in FIG. 1 is connected to the external input side, and the video information provided from any one of the external inputs 1 to 3 is displayed on the display 11 (S401). The key delivery unit 56 determines whether the channel UP/DOWN key has been pressed or not (S402). When the channel UP/DOWN key has been pressed, the key code of the channel UP/DOWN key is delivered to the receiver application management unit 53. The receiver application management unit 53 delivers the key code to the receiver application 51a (S403). After receiving the key code, the receiver application 51a turns the switch 41 to the ONAIR side (S404). That is, the external input mode is switched to the OCAP mode and the screen according to the OCAP application 52a is displayed on the display 11 (S405). In addition, the key delivery unit 56 also delivers the key code of the channel UP/DOWN key to the OCAP application management unit 54. The OCAP application management unit 54 delivers the key code to the OCAP application 52a (S406) After receiving the channel UP/DOWN key, the OCAP application 52a displays the channel selected according to the key instruction on the display 11.

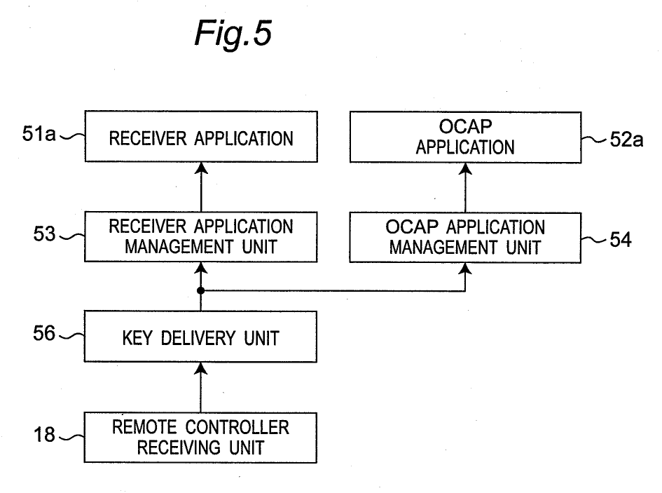

FIG. 5 shows a path of the key code delivery of the channel UP/DOWN key in S403 and S406. The key code of the channel UP/DOWN key transmitted from the remote controller 400 is received by the remote controller receiving unit 18.

The received key code is delivered to the receiver application management unit 53 by the key delivery unit 56. The receiver application management unit 53 delivers the key code of the channel UP/DOWN key to the receiver application 51a.

Although the key delivery unit 56 delivers the key code received during the external input only to the receiver application management unit 53 in the conventional case, according to the present invention, the key code of the channel UP/DOWN key is delivered also to the OCAP application management unit 54. The OCAP application management unit 54 delivers the key code of the channel UP/DOWN key to the OCAP application 52a.

Thus, the user can switch from the external input mode to the display of the channel selected by the channel UP/DOWN key by delivering the key code of the channel UP/DOWN key also to the OCAP application, even though the key code is received during the external input.

3.1.2 Control when Channel UP/DOWN Key is Pressed During EAS Forced Channel Selection

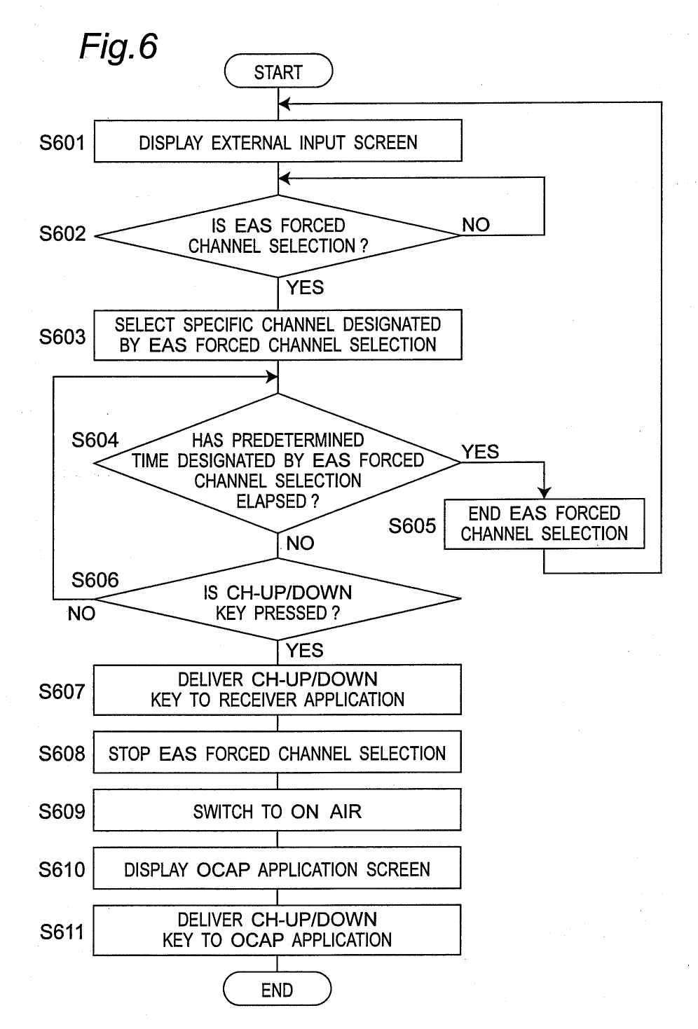

FIG. 6 shows a flowchart corresponding to FIG. 3B. Under the external input mode, the switch 41 shown in FIG. 1 is connected to the external input side and video information obtained from any one of the external inputs 1 to 3 is displayed on the display 11 (S601). In this state, the receiver application 51a determines whether the EAS forced channel selection is generated or not (S602). When the EAS forced channel selection is generated, the designated specific channel is selected (S603), the forcedly selected emergency alert broadcast is displayed on the display 11. Then, it is determined whether a predetermined time designated by the EAS forced channel selection has elapsed or not (S604). When the predetermined period has elapsed (YES in S604), the EAS forced channel selection is ended (S605) and the video information provided from the external input is displayed.

The key delivery unit 56 determines whether the channel UP/DOWN key has been pressed or not (S606) before the predetermined time elapses (NO in S604). When the channel UP/DOWN key has not been pressed, the operation returns to S604. When the channel UP/DOWN key has been pressed, the key code of the channel UP/DOWN key is delivered to the receiver application 51a through the receiver application management unit 53 (S607). The receiver application 51a stops the EAS forced channel selection (S608). The receiver application 51a turns the switch 41 to the ONAIR side (S609). That is, the external input mode is switched to the OCAP mode, and the screen according to the OCAP application 52a is displayed on the display 11 (S610). In addition, the key delivery unit 56 delivers the channel UP/DOWN key to the OCAP application 52a through the OCAP application management unit 54 (S611). When the OCAP application 52a receives the channel UP/DOWN key, it displays the channel selected according to the instruction of the key, on the display 11.

The delivery of the key code of the channel UP/DOWN key regarding S607 and S611 in FIG. 6 is the same as that regarding S403 and S406 in FIG. 4, and the key code is delivered along the path shown in FIG. 5.

When the EAS forced channel selection is performed by the receiver application 51a, although the key delivery unit 56 delivers the received key code only to the receiver application 51a through the receiver application management unit 53 in the conventional case, according to the present invention, the key code of the channel UP/DOWN key is also delivered to the OCAP application 52a through the OCAP application management unit 54. Thus, the user can switch the operation mode to the OCAP mode and select the channel selected by the channel UP/DOWN key even during the EAS forced channel selection.

3.2 Control when External Input Mode is Changed Back to OCAP Mode

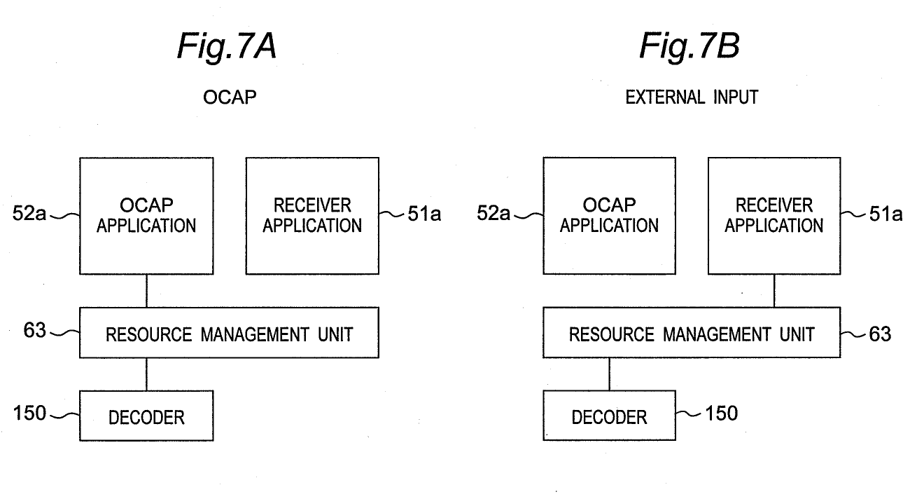

When any one of the external inputs 1 to 3 is 1394 (i. LINK) for reproducing the digital recording, digital data is transmitted from the external device to the receiver 100. The receiver 100 retrieves the transport stream (TS) from the inputted digital data and decodes it by the decoder 150, and the decoded video is displayed on the display 11. Thus, in the case of 1394, the resource of the decoder 150 is used to process the digital data from the external device. Therefore, when the OCAP mode is switched to the external input mode, some resources of the decoder 150 are taken away for the external input. FIGS. 7A and 7B show the conditions of the resource managements under the OCAP mode and the external input mode. Under the OCAP mode shown in FIG. 7A, the OCAP application 52a uses the resource of the decoder 150, and the resource management unit 63 manages the resource used by the OCAP application 52a. Under the external input mode shown in FIG. 7B, the receiver application 51a uses the resource of the decoder 150, and the resource management unit 63 manages the resource used by the receiver application 51a.

Although the OCAP application knows that the resource is taken away by another application, it does not know the resource is taken away by the receiver application like the switching to the external input mode or it is taken away temporally. Therefore, the OCAP application could make an abnormal movement, so that the OCAP application is forced to return to the initial state in the conventional case. Thus, when the external input mode is switched back to the OCAP mode, the problem is that the initial screen of the OCAP application is displayed. Meanwhile, according to the present invention, when the external input mode is switched back to the OCAP mode, the screen before switched to the external input mode can be displayed without being returned to the initial screen.

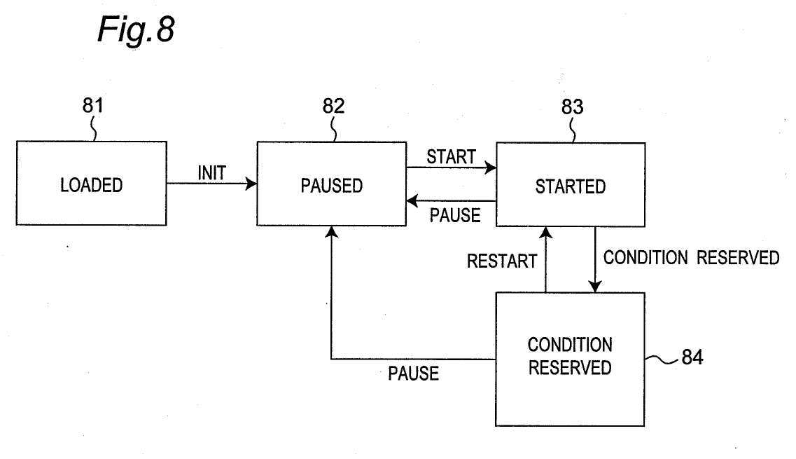

FIG. 8 shows the transition of the condition of the OCAP application 52a. The OCAP application 52a has a loaded condition 81 in which data of the OCAP application 52a is loaded, a paused condition 82 as a standby state in which the operation can be performed as soon as the resource is got, and a started condition 83 in which the necessary resource is got and the screen is displayed.

The OCAP application 52a moves from the loaded condition 81 to the paused condition 82 by Init instruction from the receiver 100, and moves from the paused condition 82 to the started condition 83 by Start instruction from the receiver 100. In the started condition 83, a drawing is made or the video is reproduced. When the condition is changed to the started condition 83 by the Start instruction, the OCAP application 52a displays the initial screen.

In the conventional case, when the OCAP mode is switched to the external input mode, the receiver 100 outputs the Pause instruction and move the OCAP application 52a from the started condition 83 to the paused condition 82. Therefore, when the mode becomes the OCAP mode again and the condition is changed back to the started condition 83, the initial screen is displayed.

According to the present invention, a condition reserved condition 84 is newly provided so that the OCAP application 52a displays the screen in the condition before switching to the external input mode. According to the condition reserved condition 84, the resource condition is retained on the condition that there is no resource.

When the OCAP application management unit 54 outputs the Condition Reserved instruction to the OCAP application 52a, the OCAP application 52a is moved to the condition reserved condition 84. In other words, the OCAP application 52a does not end the operation even when the resource is taken away, and retains the condition of the resource. At this time, the OCAP application 52a retains the condition of the resource that is retained and could be taken away by the data process of the external input. The condition of the resource means settings of a hardware or software. More specifically, the following resource conditions (a)-(g) are retained. (The term between double quotation marks in (a)-(g) is a class name of OCAP standard.)

(a) The resolution and aspect ratio of a logical video plane “HVideoDevice”

(b) The resolution and aspect ratio of a logical graphics plane “HGraphicsDevice”

(c) The drawn contents, resolution and aspect ratio of a logical still plane “HBackgroundDevice”

(d) The frequency and modulation method such as 64QAM and 253QAM of a tuner accessing a cable network “Network Interface”

(e) The key of acquirement of an input event such as a remote controller key “EventManager”

(f) The PID (Packet ID), Table ID, and Bit Mask of a MPEG section filter “SectionFilter”

(g) The line, field, and data type of a VBI (Vertical Blanking Interval) filter “VBIFilter”

Under the condition reserved condition 84, when the OCAP application management unit 54 outputs the Restart instruction, the OCAP application 52a moves back to the started condition 83 and resets the resource based on the above retaining resource condition. Thus, the screen before the transition to the condition reserved condition is displayed. Under the condition reserved condition 84, when the OCAP application management unit 54 outputs the Pause instruction, the condition is brought back to the paused condition 82.

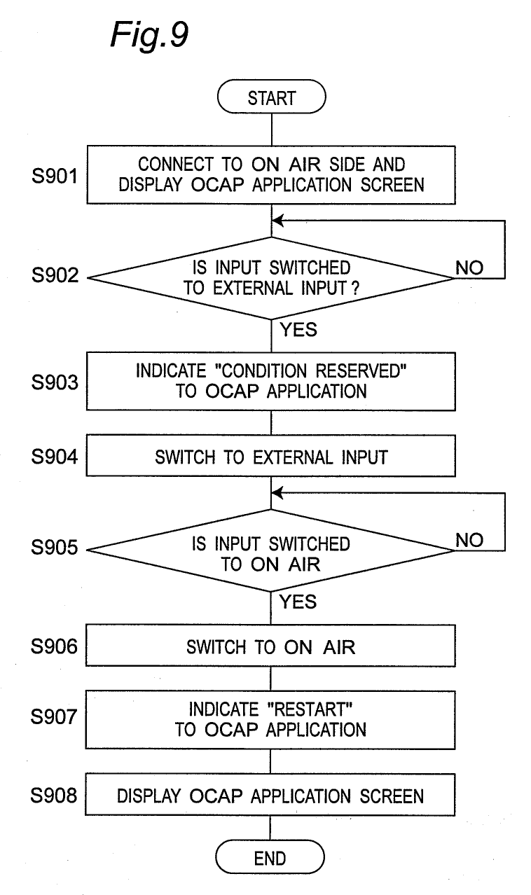

FIG. 9 shows a flowchart of the control of the OCAP application by the receiver application management unit 53, the receiver application 51a and the OCAP application management unit 54 when the operation mode is switched from the OCAP mode to the external input mode and then the operation mode is switched back to the OCAP mode. Under the OCAP mode, the receiver application 51a connects the switch 41 to the ONAIR side and the screen according to the OCAP application 52a is displayed (S901). The key delivery unit 56 determines whether the mode has been switched to the external input or not, that is, whether the key code to switch to the external input is received through the remote controller receiving unit 18 or not (S902). When the mode has been switched to the external input, the OCAP application management unit 54 outputs the Condition Reserved instruction to the OCAP application 52a (S903). The key delivery unit 56 transmits the key code for switching to the external input, to the receiver application management unit 53, and the input switching key is delivered from the receiver application management unit 53 to the receiver application 51a. The receiver application 51a turns the switch 41 to the external input side (S904).

The key delivery unit 56 determines whether the key code for input switching to the ONAIR has been received from the remote controller 400 during the external input mode or not (S905). When the key code for the input switching is received, the key delivery unit 56 delivers the key code to the receiver application management unit 53, and the receiver application management unit 53 delivers the key code to the receiver application 51a. The receiver application 51a turns the switch 41 to the ONAIR side (S906). The OCAP application management unit 54 outputs the Restart instruction to the OCAP application 52a (S907), and the OCAP application 52a is displayed on the display 11 (S908).

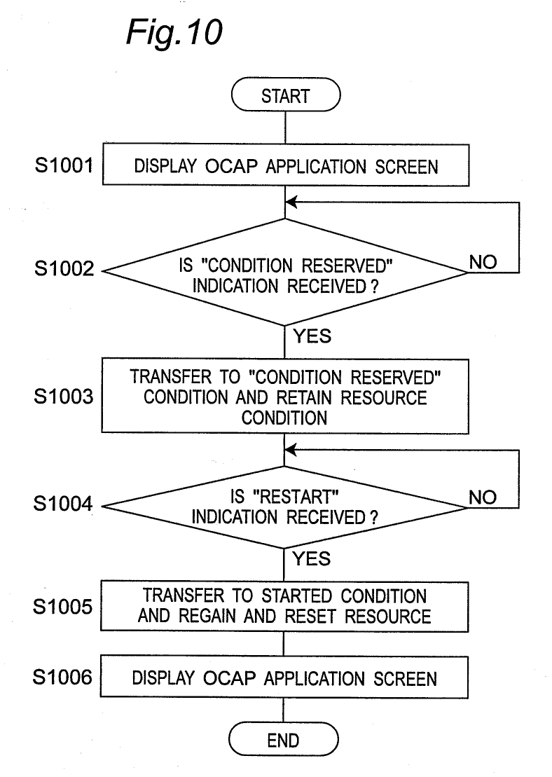

FIG. 10 shows a flowchart of the control of the OCAP application 52a itself, corresponding to FIG. 9. Under the OCAP mode, the screen according to the OCAP application 52a is displayed on the display 11 (S1001). The OCAP application 52a determines whether the Condition Reserved instruction has been received from the OCAP application management unit 54 or not (S1002). When the OCAP application 52a receives the condition reserved instruction, it becomes the condition reserved condition 84 and retains the resource condition (S1003).

Then, the OCAP application 52a determines whether the Restart instruction has been received or not (S1004). When the OCAP application 52a receives the Restart instruction, it becomes the started condition 83. The OCAP application 52a regains the resource and resets the condition of the regained resource based on the retained resource condition in S1003 (S1005). Thus, the screen of the OCAP application before transited to S1003 is displayed on the display 11 (S1006).

Thus, since the condition reserved condition 84 is newly added to the conditions of the OCAP application 52 and the condition of the necessary resource is retained, when the OCAP application 52 regains the resource and becomes the started condition 83 again, the screen before the transition can be displayed.

3.3 Control when OCAP Mode is Switched to External Input Mode

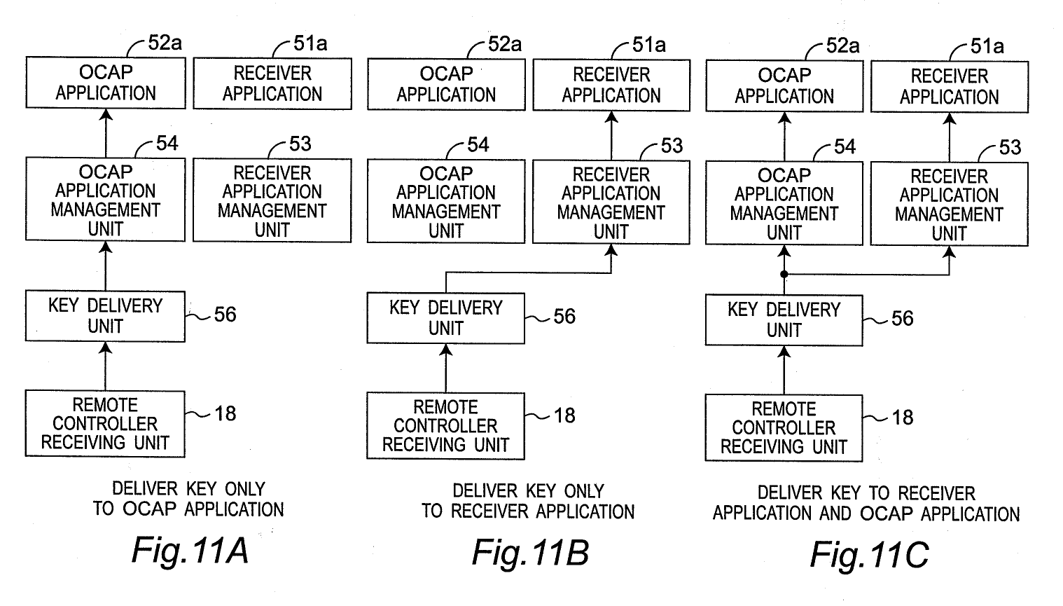

The general delivery of the key will be described with reference to FIGS. 11A-11C. FIG. 11A shows a path when the key is delivered only to the OCAP application. The key only for the OCAP application such as a VOD (Video on Demand) key is delivered only to the OCAP application 52a. FIG. 11B shows a path when the key is delivered only to the receiver application. A key only for the receiver such as the conventional input switch key is delivered only to the receiver application 51a. FIG. 11C shows a path when the key is delivered to the receiver application and the OCAP application. A common key such as a volume key is delivered to both of the receiver application 51a and the OCAP application 52a. The delivery of the key corresponds to the delivery of the key code allotted to the key in this embodiment.

As shown in FIGS. 11A to 11C, the key from the remote controller 400 received by the remote controller receiving unit 18 is delivered by the key delivery unit 56 to the receiver application management unit 53 or the OCAP application management unit 54. The key delivery unit 56 determines, based on the content of key, whether to deliver the key only to the receiver application management unit 53, only to the OCAP application management unit 54, or to both of them. The receiver application management unit 53 delivers the key to the receiver application 51a and the OCAP application management unit 54 delivers the key to the OCAP application 52a.

Conventionally, the key is delivered from the remote controller receiving unit 18 to the OCAP application 52a and/or the receiver application 51a in one-way direction. In this case, when the receiver 100 receives the input switch key during the OCAP mode, the input switch key is only delivered to the receiver application 51a as shown in FIG. 11B, and the receiver application 51a switches the mode from the OCAP mode to the external input mode.

However, only the OCAP application knows whether the mode can be switched to the external input mode during the watching the VOD under the OCAP mode, and the receiver application does not know whether the switching can be performed or not. Thus, the problem is that the receiver application performs the input switching even when the input switching cannot be performed. Here, the condition in which the input switching cannot be performed means the condition in which the OCAP application does not want to perform the input switching. For example, in the case where the VOD is allowed to be reproduced only once or in the case where it can be only watched for a predetermined time, when the VOD reproduction is started once, the OCAP application 52a does not want to perform the input switching until the VOD reproduction ends. However, since the receiver application 51a does not know the condition of the VOD, when the input switch key is pressed, the receiver application 51a performs the input switching. Thus, according to the present invention, the receiver application 51a can perform the input switching only when the input switching can be performed even when the VOD is watched under the OCAP mode.

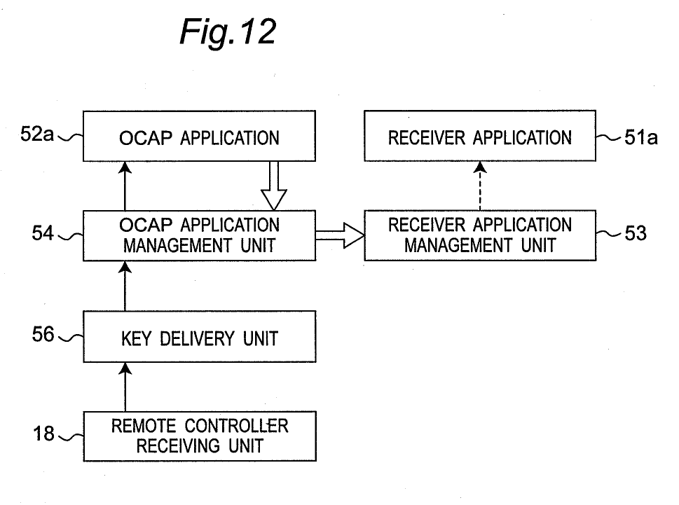

FIG. 12 shows a path of the key delivery when the input switch key is received in this embodiment. When the remote controller receiving unit 18 receives the input switch key, the key delivery unit 56 delivers the input switch key to the OCAP application management unit 54. The OCAP application management unit 54 delivers the key to the OCAP application 52a. When the OCAP application 52a receives the key, it determines whether the input switching can be performed or not. For example, when the VOD which is being reproduced can be reproduced repeatedly, the OCAP application 52a determines that the input switching can be performed, and when the time and number limits are provided for the VOD which is being reproduced, the OCAP application 52a determines that the input switching cannot be performed. The OCAP application 52a returns the key to the OCAP application management unit 54 only when it is determined that the input switching can be performed. The OCAP application management unit 54 delivers the returned key to the receiver application management unit 53. When the receiver application management unit 53 receives the key, it delivers that key to the receiver application 51a.

Thus, according to this embodiment, the key delivery unit 56 delivers the input switch key to the OCAP application 52a through the OCAP application management unit 54. Then, the input switch key is delivered to the receiver application 51a only when the OCAP application 52a determines that the input switching can be performed. Since the OCAP application 52a determines whether the input switching can be performed or not, the switching from the OCAP mode to the external input mode is executed only when the input switching can be performed, and it cannot be executed when the input switching cannot be performed.

In addition, although the key is not returned when the OCAP application 52a determines that the input switching cannot be performed in this embodiment, the OCAP application 52a may return the key together with the information for prohibiting the input switching, to the OCAP application management unit 54. In this case, the OCAP application management unit 54 delivers the key together with the information for prohibiting the input switching, to the receiver application management unit 53. Even when the receiver application management unit 53 receives the key, in the case where the information for prohibiting the input switching is added, it does not deliver the key to the receiver application 51a. Alternatively, the receiver application management unit 53 may deliver the key with the information for prohibiting the input switching received from the OCAP application management unit 54, to the receiver application 51a, and when the receiver application 51a receives the information for prohibiting the input switching together with the key, it does not perform the input switching.

3.4 Control when EPG Key is Pressed During External Input Mode

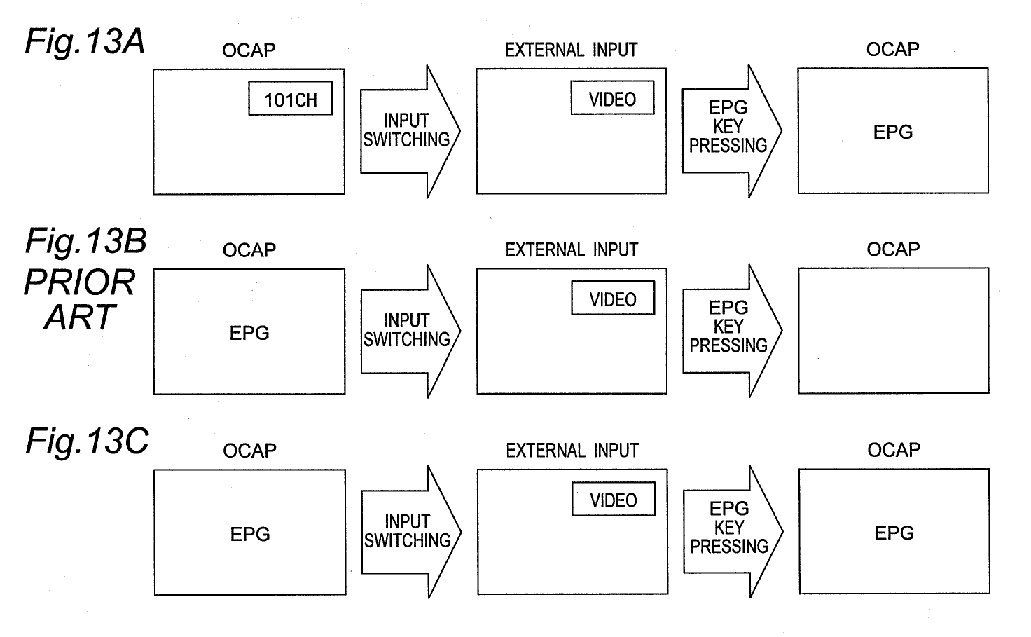

The receiver 100 performs a toggle operation such that when a key for displaying an electronic program guide (EPG), which is provided on the remote controller 400, is pressed once, the receiver 100 displays the EPG, and when the key is pressed again, the receiver 100 erases the display of the EPG. FIGS. 13A-13C show EPG display/non-display when the EPG key is pressed during the external input mode. FIG. 13A shows the transition in the case where under the condition that the EPG is not displayed under the OCAP mode, the mode is switched to the external input mode and the EPG is pressed during the external input mode. In this case, the mode is returned to the OCAP mode and the EPG is displayed. FIG. 13B shows the conventional transition in the case where under the condition that the EPG is displayed under the OCAP mode, the mode is switched to the external input mode and the EPG key is pressed during the external input mode. In this case, as viewed from the OCAP application, since the EPG key is pressed again under the condition that the EPG is displayed, the EPG is not displayed. Thus, even when the mode is switched to the OCAP mode, EPG is not displayed on the display 11. Thus, according to this embodiment, as shown in FIG. 13C, under the condition that the EPG is displayed under the OCAP mode, even when the mode is switched to the external input mode and the EPG key is pressed under the external input mode, the EPG can be displayed back under the OCAP mode.

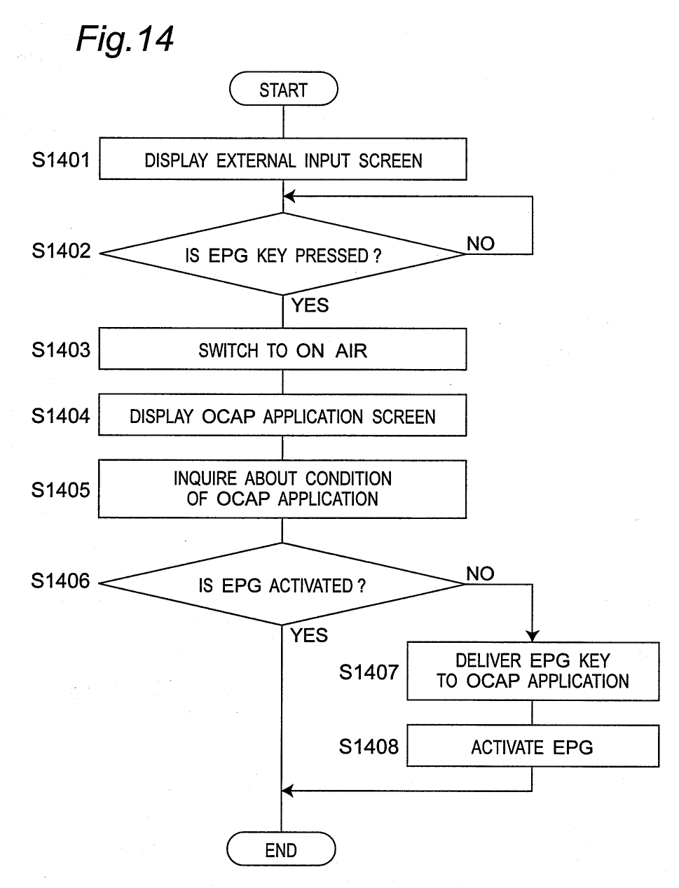

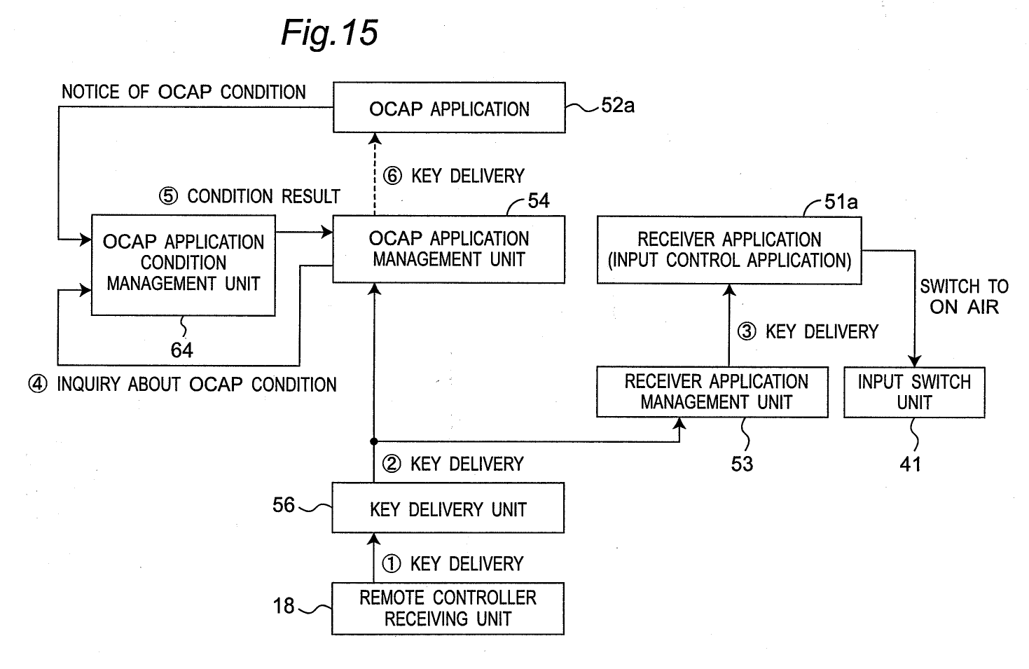

FIG. 14 shows a flowchart of the control when the EPG key is pressed under the external input mode. FIG. 15 shows a path of the delivery of the EPG key. The delivery of the EPG key when the EPG key is pressed under the external input mode will be described with reference to FIGS. 14 and 15. The delivery of the EPG key means the delivery of the key code “VK_GUIDE” of the EPG key. Under the external input mode, the switch 41 as the input switching unit is connected to the external input side, and the video information from the external device is displayed (S1401).

The key delivery unit 56 determines whether the EPG key has been pressed or not (S1402). More specifically, when the EPG key on the remote controller 400 is pressed, the remote controller receiving unit 18 receives the key and sends it to the key delivery unit 56. When the key delivery unit 56 determines that the EPG key has been pressed, it delivers the key to the receiver application management unit 53. The receiver application management unit 53 delivers the key to the input control application of the receiver application 51a. The receiver application 51a switches the switch 41 to the ONAIR side (S1403), and displays the screen of the OCAP application 52a on the display 11 (S1404).

In addition, the key delivery unit 56 also delivers the EPG key to the OCAP application management unit 54. The OCAP application management unit 54 makes inquiries about the condition of the OCAP application 52a with the OCAP application condition management unit 64 (S1405). In this case, it makes inquiries whether the EPG is being activated or not. The OCAP application 52a notifies the OCAP application condition management unit 64 of its condition periodically, or when the condition is switched. When the OCAP application condition management unit 64 receives the inquires about the condition of the OCAP application from the OCAP application management unit 54, it notifies the OCAP application management unit 54 of the condition of the OCAP application 52a. That is, it notifies the OCAP application management unit 54 whether the EPG is being activated or not. The OCAP application management unit 54 determines whether the EPG is being activated or not (S1406). When the EPG is being activated, the key is not delivered to the OCAP application 52a. The OCAP application management unit 54 delivers the key to the OCAP application 52a when the EPG is not being activated (S1407). The OCAP application 52a activates the EPG (S1408).

Thus, the OCAP application condition management unit 64 manages the condition of the OCAP application 52a and when the EPG key is pressed, the OCAP application management unit 54 make inquiries about the condition of the OCAP application with the OCAP application condition management unit 64 and determines whether or not to deliver the EPG key to the OCAP application 52a based on the above result. Thus, when the EPG is being activated, the EPG key can be controlled so as not to be delivered to the OCAP application. Thus, after the mode is switched to the external input mode under the condition where the EPG is displayed, even when the EPG key is pressed under the external input mode, the EPG can be prevented from being undisplayed.

In addition, although the description has been made of the case where the EPG key is pressed in this embodiment, the present invention is not limited to the EPG key. This embodiment can be advantageously applied to the key for the toggle operation. For example, it can be also applied to a VOD key for the video on demand or a MENU key for displaying a menu.

The present invention has the effect that the various kinds of problems caused by the switching between the OCAP mode and the external input mode can be solved, and it is advantageously useful for the OCAP mode compliant digital broadcast receiver.

Although the present invention has been described in connection with specified embodiments thereof, many other modifications, corrections and applications are apparent to those skilled in the art. Therefore, the present invention is not limited by the disclosure provided herein but limited only to the scope of the appended claims. The present disclosure relates to subject matter contained in Japanese Patent Application No. 2007-215520, filed on Aug. 22, 2007, which is expressly incorporated herein by reference in its entirety.

What is claimed is:

1. A digital broadcast receiver which has operating modes including a first mode and a second mode, the digital broadcast receiver being operated based on a download application acquired through a network under the first mode and operated based on an incorporated receiver application under the second mode, the digital broadcast receiver being operated under the second mode when information inputted from an external device is to be displayed, said digital broadcast receiver comprising:
a download application management unit that controls whether or not to deliver a key code to the download application;
a receiver application management unit that controls whether or not to deliver a key code to the receiver application; and
a key delivery unit that delivers a key code outputted from a remote controller to the download application management unit and/or the receiver application management unit,
wherein, the key delivery unit delivers, upon receiving a key code instructing a channel change during the operation under the second mode, the key code instructing the channel change to both of the download application management unit and the receiver application management unit.

2. The digital broadcast receiver according to claim 1, wherein
when the key delivery unit receives the key code instructing the channel change while the receiver application is displaying an emergency alert broadcast, the key delivery unit delivers the key code to both of the download application management unit and the receiver application management unit.

3. A digital broadcast receiver which has operating modes including a first mode and a second mode, the digital broadcast receiver being operated based on a download application acquired through a network under the first mode and operated based on an incorporated receiver application under the second mode, the digital broadcast receiver being operated under the second mode when information inputted from an external device is to be displayed, said digital broadcast receiver comprising:
a decoder that decodes digital data from the download application and the external device; and
a resource management unit that manages a resource of the decoder used by the download application or the receiver application, wherein
the download application has a first condition in which the resource is acquired to display a screen, and a second condition in which a condition of the resource is retained, and
when an operating mode is switched from the first mode to the second mode, the download application changes from the first condition to the second condition, and when an operating mode is switched from the second mode to the first mode, the download application changes from the second condition to the first condition, to reset the resource managed by the resource management unit, based on the retained resource condition.

4. A digital broadcast receiver which has operating modes including a first mode and a second mode, the digital broadcast receiver being operated based on a download application acquired through a network under the first mode and operated based on an incorporated receiver application under the second mode, the digital broadcast receiver being operated under the second mode when information inputted from an external device is to be displayed, said digital broadcast receiver comprising:
a download application management unit that controls whether or not to deliver a key code to the download application;
a receiver application management unit that controls whether or not deliver a key code to the receiver application; and
a key delivery unit that delivers a key code outputted from a remote controller to the download application management unit and/or the receiver application management unit,
wherein the key delivery unit delivers a key code to the download application through the download application management unit when the key code indicates the switching from the first mode to the second mode,
the download application determines whether or not the switching from the first mode to the second mode can be performed, and when the switching can be performed, the download application returns the key code to the receiver application management unit through the download application management unit, when the switching cannot be performed, the download application does not return the key code to the receiver application management unit or the download application returns the key code with information of prohibiting the switching to the receiver application management unit, and
the receiver application management unit delivers the key code to the receiver application when the key code is returned and the information of prohibiting the switching is not added.

5. A digital broadcast receiver which has operating modes including a first mode and a second mode, the digital broadcast receiver being operated based on a download application acquired through a network under the first mode and operated based on an incorporated receiver application under the second mode, the digital broadcast receiver being operated under the second mode when information inputted from an external device is to be displayed, said digital broadcast receiver comprising:
a download application management unit that controls whether or not to deliver a key code to the download application;
a receiver application management unit that controls whether or not to deliver a key code to the receiver application;
a key delivery unit that delivers a key code outputted from a remote controller to the download application management unit and/or the receiver application management unit; and
a download application condition management unit that manages a condition of the download application,
wherein when the key delivery unit receives, under the second mode, a key code of a key for performing a toggle operation for the first mode, the key delivery unit delivers the key code to the receiver application management unit and the download application management unit, and
when the download application management unit receives the key code, the download application management unit inquires of the download application condition management unit about a condition of the download application, and when the download application management unit determines that inversion of the toggle operation is necessary based on a result of the inquiry, the key code is delivered to the download application.
